(19) United States
(12) Patent Application Publication
(10) Pub. No.: US 2009/0222742 A1
(43) Pub. Date: Sep. 3, 2009

(54) CONTEXT SENSITIVE COLLABORATION ENVIRONMENT

(75) Inventors: Gregory Dean Pelton, Raleigh, NC (US); Lisa Louise Bobbitt, Cary, NC (US); William Henry Morrison, IV, Cary, NC (US)

Correspondence Address: TUROCY & WATSON, LLP, 127 Public Square, 57th Floor, Key Tower, CLEVELAND, OH, 44114, US

(73) Assignee: CISCO TECHNOLOGY, INC., San Jose, CA (US)

(21) Appl. No.: 12/041,218

(22) Filed: Mar. 3, 2008

(51) Int. Cl. G06F 15/16; G06F 15/18; G06F 3/14

(52) U.S. Cl. 715/753; 709/205; 706/12

(57) ABSTRACT

A system (and corresponding method) that enables establishment of an immersive collaborative environment is provided. The immersive collaborative environment represents a context-based virtual rendering of a user environment. More particularly, the virtual rendering can be associated with project or activity specific ‘rooms’ or ‘spaces.’ Within the virtual space, a resources such as data, applications and contacts can be made dynamically available to a user based upon the user context at any given moment. For example, the rendering can be employed in a business or other activity production workflow scenario thereby enhancing efficiency and productivity.

### BACKGROUND

Virtual Reality (VR) refers to a technology which allows a user to interact within a computer-simulated environment. Generally, this computer-simulated environment can relate to a real or imagined scenario. Current VR environments are primarily visual experiences which are displayed either via a monitor or through specialized stereoscopic displays (e.g., goggles). In addition to visual effects, some simulations include additional sensory information, for example, audible or vibratory sensations. More advanced, ‘haptic’ systems now include tactile information, generally known as ‘force feedback,’ in many gaming applications.

Today, users most often interact with a VR environment by way of standard input devices such as a keyboard, mouse, joystick, trackball or other navigational device. As well, multimodal devices such as a specialized haptic wired glove are used to interact with and within the VR environment.

Recent developments in VR have been directed to three-dimensional (3D) gaming environments. Generally, a ‘virtual world’ is a computer-based simulated environment intended for its users to inhabit and interact via avatars. An ‘avatar’ refers to a representation of a user usually employed by way of the Internet to depict a user. An avatar can be a 3D model used in computer games, a two-dimensional image (e.g., icon) used within Internet and other community forums (e.g., chat rooms) as well as text constructs usually found on early systems. Thus, presence within the 3D virtual world is most often represented in the form of two or 3D graphical representations of users (or other graphical or text-based avatars).

Today, nature and technology are equally integrated into 3D virtual worlds in order to enhance the reality of the environment. For example, actual topology, gravity, weather, actions and communications are able to be expressed within these virtual worlds thereby enhancing the reality of the user experience. Although early virtual world systems employed text as the means of communication, today, real-time audio (e.g., voice-over-Internet Protocol (VoIP)) is most often used to enhance communications.

Although the technological advances in graphics and communications have vastly improved the quality of the virtual worlds, these virtual environments have been centered around the gaming industry. As such, users control actions and the systems are preprogrammed with responses to those actions.

Somewhat similar to VR, ‘Augmented Reality’ (AR) most often relates to a field of computer research that describes the combination of real world and computer generated data. Conventionally, AR employs with the use of video imagery which is digitally processed and ‘augmented’ with the addition of computer-generated graphics. Similar to VR, traditional uses of AR have been primarily focused around the gaming industry.

Most often, conventional AR systems employed specially-designed translucent goggles. These goggles enable a user to see the real world as well as computer-generated images projected atop of the real world vision. These systems attempt to combine real world vision with a virtual world. Unfortunately, traditional systems fall short in their ability to leverage the vast amount of information and data now available to users.

### BRIEF DESCRIPTION OF THE DRAWINGS

FIG. 1 illustrates an example virtual workspace management system that establishes an immersive collaborative display in accordance with an aspect of the specification.

FIG. 2 illustrates an example flow chart of procedures that facilitate establishment of an immersive collaborative display in accordance with an aspect of the disclosure.

FIG. 3 illustrates a block diagram of a high-level component system that facilitates immersive collaboration in accordance with embodiments of the specification.

FIG. 4 illustrates an alternative block diagram of a virtual workspace management component that employs monitor and resource collaboration components to establish an immersive collaborative display in accordance with aspects of the specification.

FIG. 5 illustrates an example block diagram of a monitor component that establishes content, contacts and context in accordance with aspects of the disclosure.

FIG. 6 illustrates an example set of context data that is employed to establish an immersive collaborative display in accordance with an aspect of the specification.

FIG. 7 illustrates an example configuration component in accordance with an embodiment of the specification.

FIG. 8 illustrates an example two-dimensional (2D) immersive collaborative page in accordance with an aspect of the disclosure.

FIG. 9 illustrates an example three-dimensional (3D) immersive collaborative display in accordance with an aspect of the specification.

FIG. 10 illustrates a block diagram of a computer operable to execute the disclosed architecture.

FIG. 11 illustrates a schematic block diagram of an exemplary computing environment in accordance with the subject specification.

### DESCRIPTION

### Overview

The following presents a simplified overview of the specification in order to provide a basic understanding of some example aspects of the specification. This overview is not an extensive overview of the specification. It is not intended to identify key/critical elements of the specification or to delineate the scope of the disclosure. Its sole purpose is to present some concepts of the specification in a simplified form as a prelude to the more detailed description that is presented later.

This specification discloses enablement of appropriate technology and processes to create the paradigm shift that moves real-life enterprises into the immersive world that was traditionally reserved for three-dimensional (3D) gaming technologies. Essentially, integrated data in an immersive collaboration environment can provide for activating changes in behaviors of persons—awareness is critical to efficiency and productivity.

The concepts disclosed and claimed herein, in one aspect thereof, comprise a system (and corresponding method) that enables establishment of an immersive collaborative environment. The immersive collaborative environment represents a context-based virtual rendering of user environment. In one aspect, the rendering is based upon a business or other activity workflow scenario.

In another aspect of the subject system enables creation of virtual (e.g., immersive) spaces which correspond to activities of a user. More particularly, the virtual spaces relate to workflow and/or states of the activities of the user. In embodiments, the immersive collaborative environment aggregates data and other relevant information in one virtual display. For instance, representations of users, applications, data, etc. are incorporated into the immersive collaborative environment by which a user can navigate as desired. Effectively, the specification discloses a representation of a common space that includes relevant ‘objects’ (e.g., data, user representations) based upon contextual factors.

Still other aspects can dynamically alter the immersive collaborative environment based upon a current, inferred or projected context. For example, as information becomes available, links or representations of the information are injected into the virtual environment. In aspects thereof, machine learning and reasoning mechanisms are provided that employ probabilistic and/or statistical-based analysis to prognose or infer appropriate presentations within the virtual or immersive collaborative environment.

To the accomplishment of the foregoing and related ends, certain illustrative aspects of the specification are described herein in connection with the following description and the annexed drawings. These aspects are indicative, however, of but a few of the various ways in which the principles of the specification can be employed and the subject specification is intended to include all such aspects and their equivalents. Other advantages and novel features of the specification will become apparent from the following detailed description of the specification when considered in conjunction with the drawings.

### BRIEF DESCRIPTION OF EXAMPLE EMBODIMENTS

The specification is now described with reference to the drawings, wherein like reference numerals are used to refer to like elements throughout. In the following description, for purposes of explanation, numerous specific details are set forth in order to provide a thorough understanding of the subject specification. It may be evident, however, that the specification can be practiced without these specific details. In other instances, well-known structures and devices are shown in block diagram form in order to facilitate describing the specification.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

While certain ways of displaying information to users are shown and described with respect to certain figures as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

‘Virtual Reality’ (VR) environments are often referred to as ‘immersive environments.’ However, conventional immersive environments often lack an implication that ‘reality’ is being simulated within a digital space. In accordance with embodiments of the specification, an immersive environment can be a model of reality, as well as a complete fantasy user interface or abstraction where the user of the environment is virtually immersed within it. Essentially, the term ‘immersion’ suggests that a user experiences a presence within the virtual environment. The success with which an immersive environment can actually immerse a user is dependent on many factors such as believable graphics (two-dimensional (2D), two and a half-dimensional (2½D) and three-dimensional (3D)), sound, interactive user engagement, among others.

Conventionally, immersive environments are currently used for multiplayer gaming where they offer a set of communication services along with gameplay and character development. Within these virtual worlds, people are represented as avatars and they must collaborate to achieve tasks. The environment or virtual world itself is most often rich, well structured and provides visual and auditory cues that direct the players to complete certain tasks.

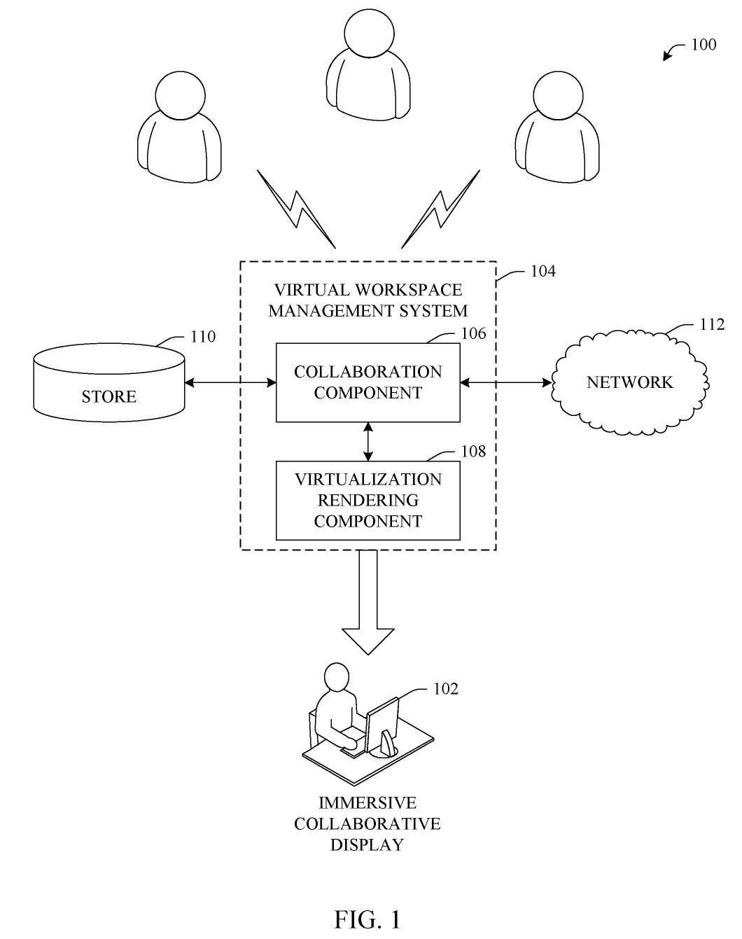

Referring initially to FIG. 1, a system 100 that establishes an immersive collaborative display 102 is shown. While conventional systems required proactive collaboration by users, the subject specification describes and discloses a system 100 which automatically aggregates resources (e.g., data, authors, links) associated with an activity within a single immersive collaborative display 102. In other words, the system 100 includes a virtual workspace management system 104 which automatically generates an immersive environment or immersive collaborative display related to an activity or workflow within an activity or project. As will be understood, in a specific embodiment, this immersive collaborative display can be related to a business or enterprise workflow. Additionally, this aggregation can be based upon a specific state, workflow or context within an activity.

While many of the aspects and embodiments described herein are directed to business or enterprise workflows, it is to be understood that most any activity- or subject-based aggregation can effected by way of the virtual workspace management system 102. For instance, system 100 can be employed to assist in personal activities such as, for example, installation of a wireless router in a home. In this example, a user can be presented with information, white papers, instruction manuals, visual presentations, weblogs, forum entries or the like that relate to the task (or workflow) of installing a router. Similarly, available resources can dynamically alter based upon state within the project/task.

As shown in FIG. 1, the virtual workspace management system 104 can include a collaboration component 106 and a virtualization rendering component 108. Essentially, based upon a detected context, the collaboration component 106 can aggregate data related to an activity workflow in view of a given context. In addition to initially aggregating relevant information from stores 110 (local and/or remote) and networks 112 (e.g., Internet-based sources), the component 106 can dynamically update and/or supplement information within the immersive collaborative display 102 as a function of context.

The virtualization rendering component 108 facilitates configuration of the data for rendering, therefore establishing the immersive collaborative display 102. For instance, the component 108 can configure the information in view of characteristic and/or limitations of a target device. For example, the display 102 can be configured differently if rendered via a smart-phone versus a desktop computer monitor. In addition to automatically detecting characteristics and/or limitations, the component 108 can also facilitate configuration based upon a predefined preference or policy. Here, the preference or policy can be based upon most any factor including, but not limited to, user preferences, enterprise policies, data type, context, state, etc.

In a specific example, an immersive virtual world (e.g., immersive collaborative display 102) can be designed to represent a business or enterprise environment. While there are many possible metaphors that could be used to describe the display 102, this specification describes the display as a collection of ‘rooms’ or ‘spaces.’ It is to be understood that, in aspects, spaces or rooms can be representative of buildings, theme-based rooms (e.g., office, lobby, living room), landscapes or other visual representations. In some examples, users are represented in the world as avatars that occupy the spaces or rooms.

As will be understood upon a review of the figures and discussion that follow, the rooms can be geographically and/or visually distinct from each other. For example, each room can represent a particular business context—e.g., construct that is representative of something from the business domain. For instance a room might represent an office, a department, a project, a process, an organization, a work product, a task, etc.

Ultimately the geography and structure of the world rendered via component 108 captures elements of the context (e.g., business context) it is supporting. Effectively, the user can be depicted in the display 102 as performing business tasks while in the virtual world. These tasks may include such tasks as working on specific documents, attending meetings or collaborating with others. The tasks may be directly supported by the virtual world or may be in adjacent workspaces.

As the user performs a task, the geography or special representation in the virtual world can adjust and reconfigure itself to provide context specific assistance to the user. One illustration of this would be a user writing a document about a product design. Here, as the user types or scrolls through the document, they could see new pictures hanging on the wall of their virtual room that represent prevalent themes in the document. Additionally, they may also be presented with objects on the floor that represent common reference material like a dictionary, a design process document, etc. Other documents related to the product, schematics, etc. may appear as files on a virtual table or presentation screen.

It is to be understood and appreciated that there are a multiplicity of different potential representations that support the visual metaphor of the virtual world and rooms. As such, this multiplicity of different representations is to be included within the scope of the specification and claims appended hereto. One feature of the system 100 is that the environment representation (102) reflects relevance to the user's current activity, and state or context within that activity. As well, the virtual workspace management system 104 enables that representation of the task or activity (102) to adapt (in (or near) real-time) as the task (or context within the task) of the user changes. Still further, the system 104 is capable of anticipating or inferring context of the user, thereby supporting efforts by providing relevant resources to the user.

The environment can be enhanced to support collaboration between the user and others who may be relevant to the user's tasks. Collaboration could take the form of voice, messaging, video, shared workspace, etc. The resources presented to a user can include avatar representations of relevant users and disparate representations of other users (e.g., for those not online or no longer available). These disparate representations can include, names, pictures, statues, ‘ghosts,’ etc. which are populated in the virtual world (102) and shown to the user at the appropriate time, for example, as relevant in view of context or state within an activity.

In a particular example, if the user is currently looking at a schematic of a hardware board, representations of the designer of the board, the manufacturing person, the tester, the parts manager may all be shown or made available for collaboration. Here, the user can select these representations to access material authored by the individual, initiate contact to the individual (e.g., via email, instant message (IM), text message, voice call, . . . ). In addition, links to other users who may be currently exploring relevant areas associated with an activity can be made available as desire or appropriate. As described above, this determination can be made in accordance with a preference or policy as well as inferred on behalf of a user.

In another example, if another user is also working on a document related to the same product or from the same organization, they could also be represented in the virtual world. It will be understood that, if desired, the environment can infer or select an appropriate means of representing the other users, for example, pictures, statues, avatars, text names, ‘ghosts,’ etc.

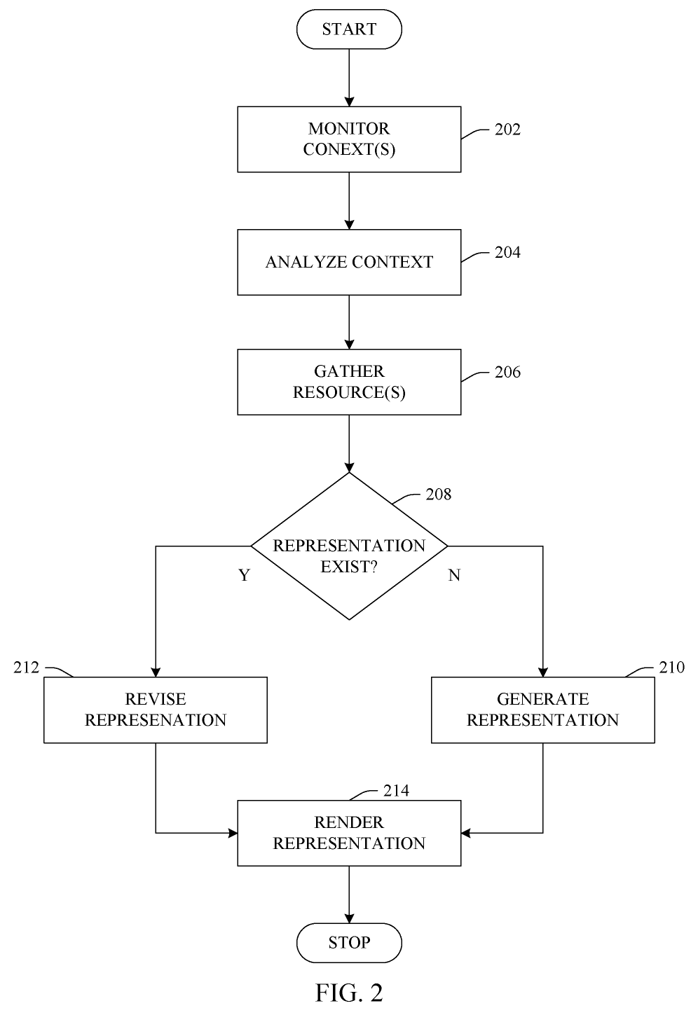

FIG. 2 illustrates a methodology of generating and maintaining an immersive collaborative display in accordance with an aspect of the specification. Generally, the methodology enables initial creation of a virtual workspace that corresponds to an activity, workflow, project, etc. Additionally, the methodology of FIG. 2 also facilitates dynamic modification or adaptation of the virtual workspace based upon dynamically changing characteristics, factors and parameters such as activity context, user context, environment context or the like.

While, for purposes of simplicity of explanation, the one or more methodologies shown herein, e.g., in the form of a flow chart, are shown and described as a series of acts, it is to be understood and appreciated that the subject specification is not limited by the order of acts, as some acts may, in accordance with the specification, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the specification.

At 202, context associated to an activity, user or environment can be monitored. Here, sensory mechanisms, webcrawlers, keystroke monitors, microphones, cameras, etc. can be used to monitor and determine (or infer) contexts which can be employed to create and maintain a virtual workspace. As described above, the virtual workspace, or immersive collaborative display (102 of FIG. 1), can include representations and links to individuals and data relevant to a particular context. For instance, suppose a user is working on a sales forecast project for ABC company—here, the display can render links to sales history, product classifications, financial documents, representations of individuals that were involved in preparation of such documents, etc. Essentially, the virtual workspace can establish collaboration of information related to an activity, workflow, project, task, etc. into a single 2D, 2½D or 3D representation.

At 204, the contextual information can be analyzed to determine characteristics, parameters, related data, related individuals, related application, etc. For instance, content analysis can be employed to establish the type of activity or project. As well, this analysis can be used to determine appropriate resources (e.g., data, people, applications) associated with the activity. It is to be understood that most any mechanism can be employed to determine relevant or otherwise associated resources. For example, preprogrammed rules, preferences, policies or the like can be used establish relevance and/or usefulness. Similarly, most any artificial intelligence, heuristics and/or machine learning & reasoning (MLR) mechanisms can be employed to infer relevance or usefulness of resources on behalf of a user based upon activity, user and/or environmental context(s).

At 206, relevant and/or useful resources can be gathered. Here, it is to be understood that ‘gathering’ the resources can refer to accessing, locating, linking, providing a link, or otherwise making the resource(s) available. In other words, the system need not actually retrieve the resource at 206.

At 208, a determination is made to verify if a current representation exists for the resource (or group of resources). As described above, a ‘representation’ can refer to most any representation or symbol related to the resource, including but not limited to, an image, statue, text string, hyperlink, ‘ghost’ or the like. Essentially, the representation can enable a user to access (or communication with) the resource as desired or appropriate.

If representation of the resource does not exist, at 210, a suitable representation is generated. Similarly, if a representation does exist but, is not accurate given a current context, the representation can be revised at 212. For example, in an aspect, relevance can be conveyed by the size, shape, color, type, location, etc. of the representation. If the current context warrants a change in the representation, at 212, the representation can be revised as appropriate.

At 214, the representation can be rendered, for example, via a desktop computer display or monitor. Similarly, the representation can be displayed via a laptop, personal digital assistant (PDA), smart-phone, television, etc. It is to be understood and appreciated that the methodology can include an act (not shown) whereby the representation is automatically configured in accordance with a target display device. For instance, object types can be selected, resized and/or modified in accordance with characteristics and/or limitations of a target display device.

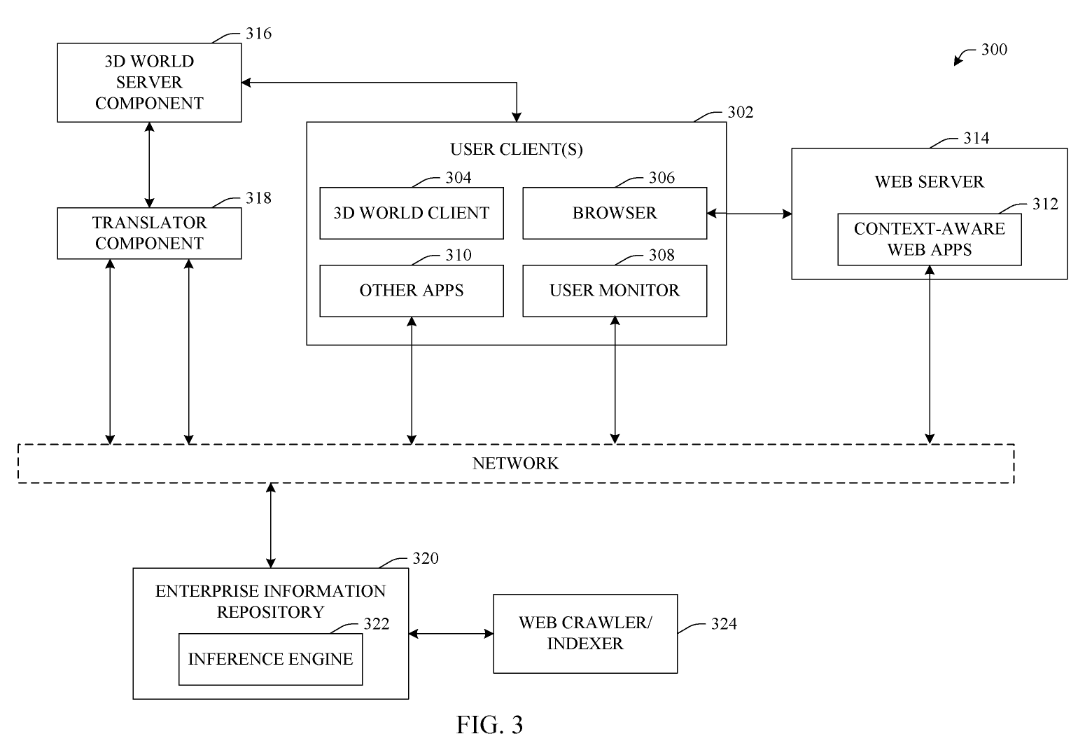

Referring now to FIG. 3, a block diagram of an immersive collaboration system 300 in accordance with an aspect of the specification is shown. While specific components are illustrated in FIG. 3, it is to be understood that alternative systems can be configured that possess the features, functions and benefits described herein. Thus, system 300 is included to add perspective to the specification and is not intended to limit the specification in any manner.

User clients 302 can include a 3D world client 304, a browser 306, a user monitor 308 and other applications 310. In operation, the user monitor 308 can observe contextual factors, including user context, activity context and environmental context. In accordance with a detected context, the 3D world client component 304 can render resources associated with such context. For example, links to other applications 310 can be provided by way of the 3D world client 304. Similarly, the browser 306 can be employed to provide access to context-aware web applications 312 employed within a web server 314.

A server-based 3D world server component 316 and translator component 318 can be provided as needed or desired to provide web based immersive collaborative features, functions and benefits. Still further, in accordance with the context, resources can be accessed by way of an enterprise information repository 320. Additionally, an inference engine 322 and web crawler/indexer 324 can be employed to assist in identification of relevant resources (e.g., data, people, links). For instance, based upon statistical and/or historical analysis and heuristics, the inference engine 322 can establish relevance, or degrees of relevance, of the information. The web crawler/indexer 324 can be employed to identify information and other resources located upon a network, for example, the Internet.

As will be understood, system 300 can not only virtualize a user's desktop but, also their workspace as a whole. Essentially, the system can determine or infer where a user is located, what they are doing, what they are using, and who they are communicating with and automatically render a two-dimensional (2D) or three-dimensional (3D) immersive collaborative display. Generally, the specification fuses content, contacts and context in a manner that enables an immersive collaborative environment traditionally reserved for 3D gaming applications.

A single view of a user's environment can be rendered and made available for others to others to join, work within, etc. The collaboration within this environment essentially makes resources (e.g., tools, data, contacts) available based upon a user's context. In operation, an avatar or other suitable representation can be used to symbolize the user within the virtual space.

Within this virtual space, data can be automatically and/or dynamically filtered and provided based upon most any relevant factors including, user activity, user role, user permission, user contacts in close proximity, etc. Similarly, as the system 300 can make this information available to a user in an effort to maximize efficiency, information from all users within a virtual space (e.g., room) can be saved or tagged in association with the room for subsequent use. As well, information can be stitched together so as to provide a cohesive and comprehensive rendition of the activity with a particular room.

One useful embodiment includes an ability to promote cross sharing of information based upon a particular context. As well, the system 300 can intelligently filter information such that a user is only presented with information useful at any moment in time. This information can be displayed via a virtual desktop which enables a view of real world resources within a technologically savvy virtual space.

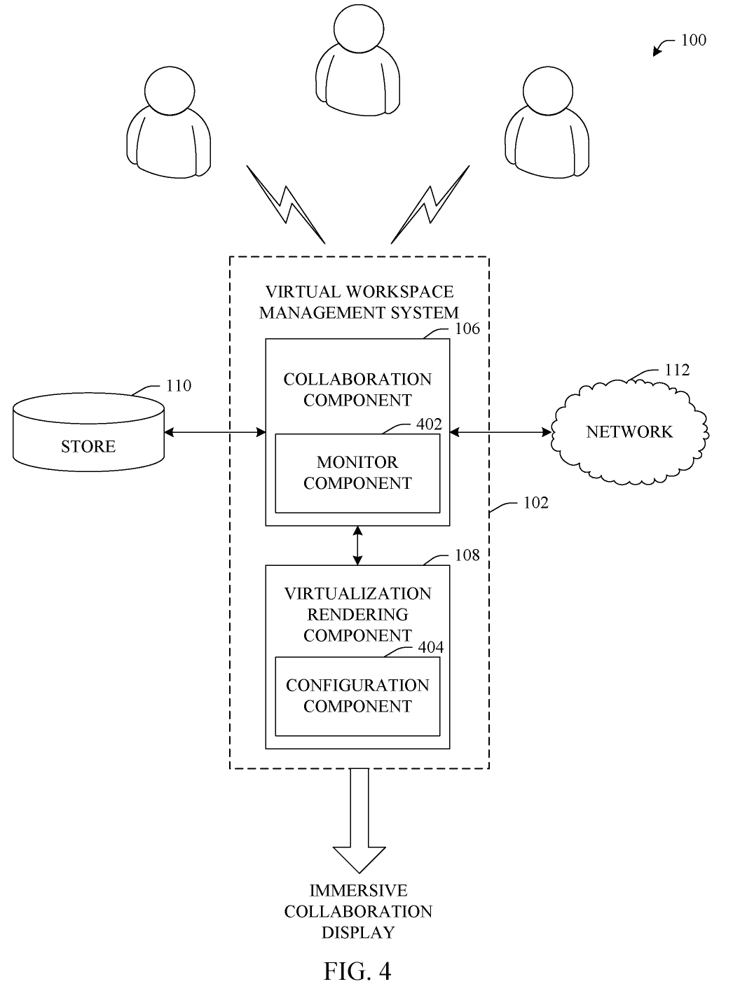

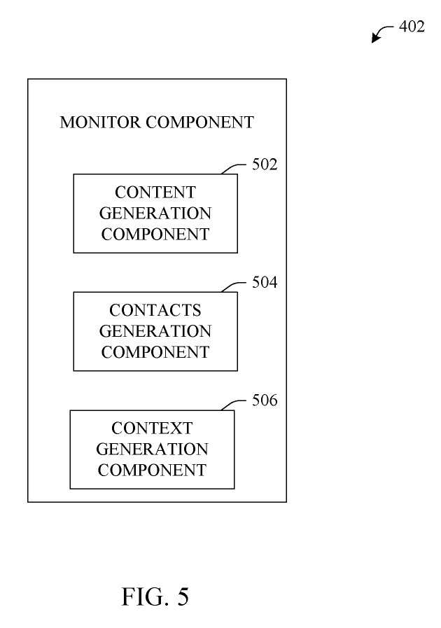

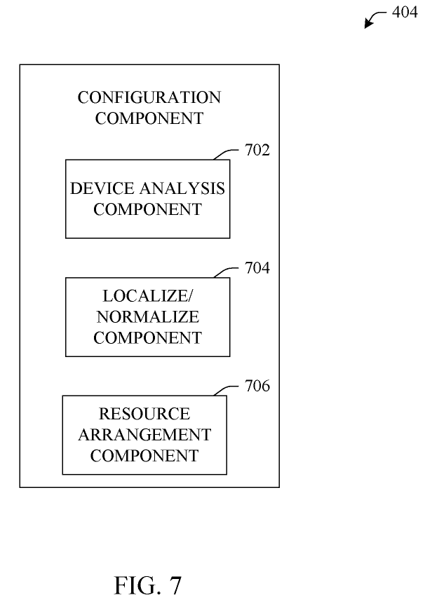

Referring now to FIG. 4, an alternative block diagram of system 100 is shown. As illustrated, the collaboration component 106 can include a monitor component 402 which facilitates establishment of context(s) in accordance with aspects of the specification. The virtualization rendering component 108 can include a configuration component 404 that can construct appropriate representations of resources for rendering via the immersive collaborative display. Each of these subcomponents (402, 404) will be described in greater detail with reference to FIGS. 5 and 7 that follow.

Turning now to FIG. 5, a block diagram of an example monitor component 402 in accordance with an aspect of the specification is shown. Generally, monitor component 402 is capable of establishing content, contacts and context by way of a content generation component 502, a contacts generation component 504 and a context generation component 506. It is to be understood and appreciated that most any sensory mechanism and/or logic can be employed to generate content, contacts and context in accordance with aspects.

For example, the content generation component 502 can be employed to monitor audible or textual conversations. Thus, speech analyzers or keyword algorithmic mechanisms can be employed to determine and/or infer content of user communications. This content can be employed by the collaboration component 106 to aggregate appropriate resources.

Similarly, the contacts generation component 504 can be employed to establish individuals in proximity or those engaged in on-going communications with the user. For example, facial recognition systems, personal information manager (PIM) data, etc. can be employed to establish associated individuals. The identity of these individuals can be employed to generate or supplement generation of a current context, which is also used to aggregate resources.

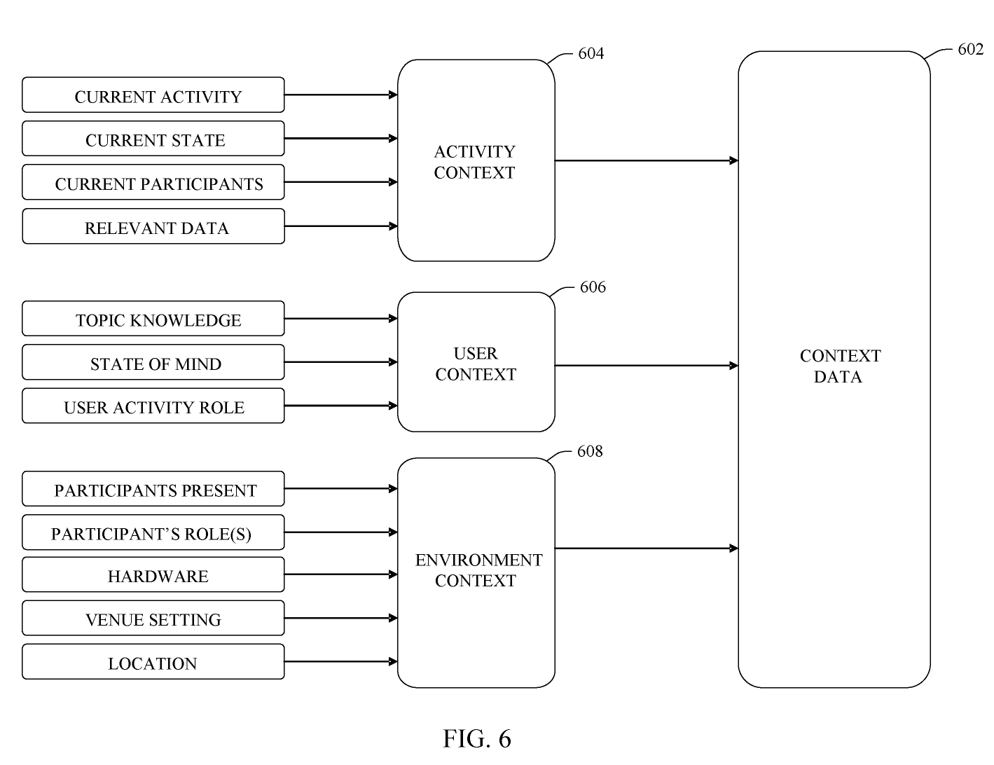

Still further, the context generation component 506 can be employed to establish contextual information which can later be used to identify appropriate resources for aggregation. As described above, most any sensory mechanisms can be employed to establish contextual information in accordance with aspects of the specification. By way of example, FIG. 6 illustrates example context information that can be established by way of the context generation component 506.

FIG. 6 illustrates an example set of contextual data that can be captured in accordance with embodiments of the specification. As shown in FIG. 6, the context data 602 can be viewed in three 3 separate categories. Namely, the context data 602 can be divided into activity context 604, user context 606, and environment context 606. It is to be understood that FIG. 6 is provided to add perspective to the features, functions and benefits and is not intended to limit the scope of the specification in any manner. Rather, it is to be understood that other categories of data can be incorporated into the context data 602 without departing from the scope of this disclosure and claims appended hereto.

By way of example, and not limitation, the activity context data 604 can include the current activity of the user (or group of users). It is to be understood that this activity information can be explicitly determined and/or inferred, for example, by way of MLR mechanisms. Moreover, the activity context data 604 can include the current status or state (if any) within the activity. The activity context data 604 can also include a list of current participants associated with the activity as well as relevant data (or resources) associated with the activity.

In an aspect, the user context data 606 can include knowledge that the user has about a particular topic associated with the activity. As well, the user context data 606 can include an estimate of the user's state of mind (e.g., happy, frustrated, confused, angry, etc.). The user context 606 can also include information related to the user's role within the activity (e.g., leader, manager, worker, programmer). It will be understood and appreciated that this user activity role information can be used to categorize (and/or filter) relevant resources by which to present to the user in a virtual environment. With reference to the user state of mind, it will be understood and appreciated that the user's state of mind can be estimated using different input modalities, for example, the user can express intent and feelings, the system can analyze pressure and movement on a mouse, verbal statements, physiological signals, etc. to determine state of mind.

With continued reference to FIG. 6, the environment context data 608 can include information such as, but not limited to, participants present, participant's roles, hardware controls, venue setting, location, etc. In an example, the venue setting can be employed to determine if the user is in a business meeting, what type of hardware display technology is available (e.g., overhead projector). As described above, although specific types of resources are identified in FIG. 6, it is to be understood that additional types of resources and information can be included within the context data 602. Accordingly, it is to be understood that these additional aspects are to be included within the scope of the disclosure and claims appended hereto.

FIG. 7 illustrates an example configuration component 404 in accordance with an aspect of the specification. Generally, the configuration component 404 can include a device analysis component 702, a localize/normalize component 704 and a resource arrangement component 706. Each of these sub-components assists in effective rendering of the immersive collaborative display (e.g., 102 of FIG. 1).

The device analysis component 702 is employed to establish parameters and/or limitations of a target device. For example, the component 702 can automatically establish display and processing characteristics of a target device. Accordingly, the configuration component 702 can be employed to configure, arrange or otherwise format the immersive collaborative display in accordance with the target device.

Essentially, the view shown in the 3D world can be modified based upon device capabilities as well as preferences. For example, a handheld device with limited display real estate will most likely render a virtual workspace (or virtual desktop) in a different manner than a dual monitor desktop computer. In the dual monitor scenario, the specification can dynamically devote a monitor (or portion thereof) to display of the 3D view enabling a user to continue uninterrupted computing via the other display.

Additionally, the rendering can be based upon session state. By way of example, bandwidth and/or connectivity can be used to determine how best to optimize display of a virtual workspace. For instance, if wireless connectivity is low, the rendering may be more limited so as to optimize usability. Similarly, if a wireless connection is strong, the system may display a more comprehensive 3D rendering of the virtual workspace.

The specification enables a user to pre-select or define rendering preferences. These preferences can be based upon device state, capabilities, user context, data content, user role, contacts role, etc. As well, the view can dynamically change as content of the virtual workspace changes. For example, as a user enters a room or selects a space, the system can re-evaluate rendering of data based upon permissions, role, etc. of the new attendee in the room.

In generating a display based upon user device and/or state, the system can inform a device of the type(s) of information available for display. Similarly, a device can evaluate capabilities. Here, the device can determine connection bandwidth, available processing resources, available memory, etc. As such, this contextual presence can be used to establish an optimized yet, efficient rendering of the virtual workspace. Other factors considered in the contextual presence can be device owners, locations, public/private factors, or the like. In operation, virtual workspaces can be migrated or handed-off to other devices (e.g., smart-phone to desktop computer). In these scenarios the rendering can be dynamically adjusted based upon factors of the target device.

In one example, virtual rooms can be aggregated or viewed separately based upon device capabilities/limitations as well as user preferences. Still further, machine learning and/or reasoning mechanisms can be employed to enhance the ability to render a virtual workspace. For instance, over time, the system can learn user preferences in certain situations and can thereafter automatically infer or make decisions on behalf of a user.

The localize/normalize component 704 can be employed to automatically configure the display in accordance with local dialects, customs, etc. For example, although some of the resources may have been authored in a specific language (e.g., English), once the environmental context is established, the display can be automatically modified into a language/dialect based upon location and preferences of a user. By way of further example, the system can determine that a user is located in Italy and thereafter convert or translate resources into Italian thereby enhancing usability.

The resource arrangement component 706 can be employed to configure, order, rank, filter, emphasize, size, highlight, diminish, etc. resources prior to rendering. As described above, the arrangement can be based upon a preference or policy. Additionally, arrangement can be inferred based upon statistical and/or historical data. Effectively, the resource arrangement component 706 can be used to configure the resources in order to enhance and/or optimize usefulness of the immersive collaborative display.

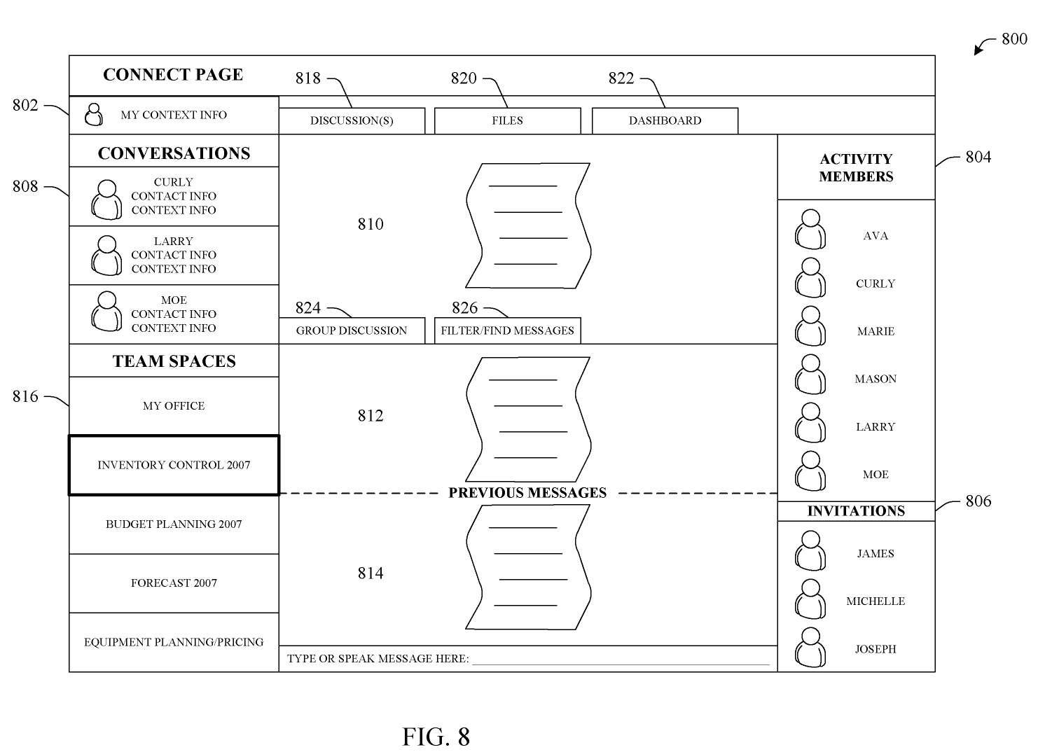

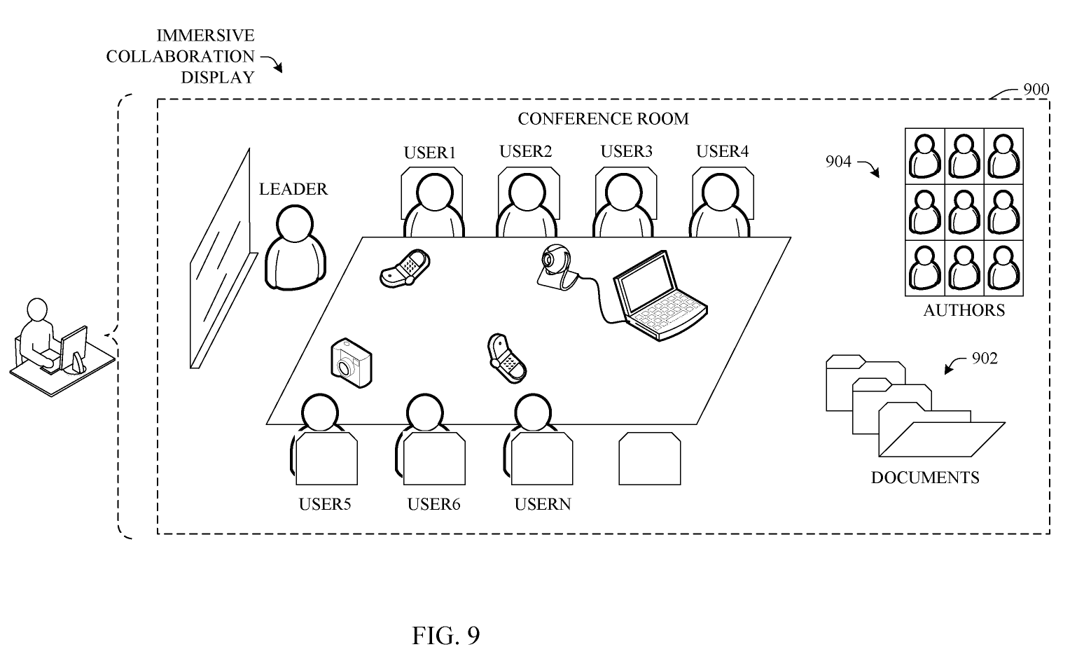

Turning now to FIGS. 8 and 9, example 2D and 3D immersive collaborative displays or pages are illustrated respectively. While example screens are shown, it is to be understood that alternative pages can be employed to illustrate the features, functions and benefits of the specification without departing from the scope of the disclosure and claims appended hereto. For example, alternative resources can be included, resources can be excluded as well as resources can be configured in a different manner than those shown in FIGS. 8 and 9 respectively.

In each of the following example screen pages, it will be understood that the information displayed within the immersive collaborative display can be aggregated in real-time and dynamically adjusted in accordance with contextual information. For instance, as a user's state changes within an activity, the information made available by the collaborative display dynamically alters to present the user with useful and relevant resources associated with the activity. As will be understood, the dynamic presentation of resources in accordance with the context can enhance the user experience thereby increasing efficiency, communications and productivity.

Referring first to FIG. 8, illustrated is a 2D view 800 of a wiki-style page associated with a current activity of a user. This view 800 aggregates a multiplicity of resources associated with an activity into a single place, the page 800 together with corresponding sub-pages or folders. While a specific set of resources are illustrated and discussed herein, it is to be understood that alternative aspects can include a disparate set of resources without departing from the spirit and/or scope of this specification.

An identifier of the page is located at 802. Here, this information can define a current context of the user or ‘owner’ of the page. For instance, contextual information can include, current activity, current location, current role, etc. This information assists in setting perspective of the association of the displayed resources.

As described above, a representation of members or individuals associated with an activity can be presented. On the example page 800, this representation is illustrated at 804. It is to be understood that most any method of emphasis (or de-emphasis) can be employed to highlight or otherwise detract attention to a member or group of members. For example, representation types can change based upon relevance, role, availability, etc. Still further, coloring, shading, size, etc. can be used to enhance visibility of a subset of activity members 804.

A user can ‘invite’ to launch a communication session with an activity member. The communication session can employ most any available protocol known including, but not limited to, IM (instant message), email, SMS (short message service), MMS (multi-media messaging service), VoIP (voice-over-Internet Protocol), conventional cell or landline service, etc. Pending invitations are shown at 806—in other words, as a user invites a user to engage in a communication session, identity of these users can be displayed in area 806.

Once a communication session has commenced, the on-going conversations can be shown at 808. Here, in addition to the identity of the on-going conversations, contact and context information can be displayed for each of the users. For example, each user's IM name, current role, etc. can be displayed in area 808. One-on-one, group discussion and previous messages (history) can be displayed at 810, 812, and 814 respectively.

Area 816 can be used to display team spaces, for example, ‘My Office,’ ‘Inventory Control 2007,’ ‘Budget Planning 2007,’ ‘Forecast 2007,’ ‘Equipment Planning/Pricing.’ In the example of FIG. 8, as illustrated, ‘Inventory Control 2007’ is selected from the list of example team spaces 816. Accordingly, the resources displayed on the page 800 dynamically correspond to the particular team space. As the user toggles between the team spaces, the resources displayed on the page 800 will dynamically change in accordance with the particular space selected. As well, if desired, it will be understood that multiple spaces can be selected at any one time—thus, the page 800 will display resources that correspond to each of the spaces.

Returning to the list(s) of messages, the page can include a ‘Discussion(s)’ folder, ‘File(s)’ folder and a ‘Dashboard’ folder, illustrated by 818, 820 and 822 respectively. Essentially the Discussions folder enables illustration of current and past discussions (and messages). Here, a ‘Group Discussion’ folder 824 can be provided to show group discussion(s) in area 812. Additionally, a ‘Find/Filter Messages’ folder 826 is provided and enables a user to search discussion(s) and/or messages based upon most any criteria, for example, sender, subject, keywords, date, time, etc.

The ‘Files’ folder 820 provides a listing of data and other documents related to the current context or activity (as selected in area 816). Additionally, the ‘Dashboard’ folder 822 provides a quick view of active resources associated to the user in a particular space or context. For example, the ‘Dashboard’ folder 822 can display open applications, files and conversations associated with a specified space.

While specific resources together with a specific layout of those resources are illustrated in FIG. 8, it is to be understood and appreciated that most any associated and/or relevant resources can be represented in the immersive collaborative display. As well, most any layout, orientation, configuration or representation can be employed without departing from the spirit and/or scope of this specification and claims appended hereto.

Turning now to FIG. 9, a 3D rendering of a ‘room’ or ‘space’ is shown in accordance with an aspect of the specification. Essentially, it is to be understood that the features, functions and benefits described herein can integrate the concepts of a 2D wiki-style page (FIG. 8) together with an immersive 3D rendering (virtual world) (FIG. 9). As shown in FIG. 8, an ordinary wiki-style page can be described as a dynamic web site made up of pages that can created and edited by end-users using a simple text markup facility. Additionally, the wiki of FIG. 8 (as well as the 3D rendering of FIG. 9) can be dynamically created by the system on behalf of the user. Integrating this with a virtual world server, the ideas present a dynamic world made up of ‘rooms’ or ‘spaces’ that can be created and edited by end-users (or on behalf of a user).

It is to be understood that the ideas offer both a 2D web-browser wiki-like text view of the virtual world (FIG. 8) and an immersive 3D view of the virtual world (FIG. 9). Both views can be dynamically updated (e.g., using ‘push’ technologies) to show real-time changes occurring in the room. Additionally, ‘pull’ technologies can be employed in other aspects. In some embodiments, users can easily toggle between the text view (2D) in the web browser and the graphical view in the 3D client. As the user browses more rooms (spaces) in the 3D client, the user's associated ‘avatar’ or representation in the virtual world moves from room to room. Representations of documents that ‘live’ in the room can appear as links on the web page; if the user opens such a link, the avatar or other representation can move to stand next to the document in the room. This functionality can be seen in FIG. 9 where the ‘Leader’ stands next to a projection screen that seemingly displays a presentation slide deck. The web page can also show which users are looking at (or editing) each document. Still further, as illustrated at 902, the display can illustrate which document (or groups of documents) is open within the space. This allows users to see what others are doing in a natural manner, regardless of the client technology they are using.

Moreover, authors of data and resources associated with a particular space can be represented within the view. For instance, as seen at 904, a picture grid of authors is illustrated. As described with reference to FIG. 8, a user can click on a desired author thereby initiating communication (e.g., IM, email, SMS, MMS, VoIP) to the selected author.

As described supra, the specification suggests inference in lieu of (or in addition to) explicit decision making. Accordingly, the systems described herein can employ MLR components which facilitate automating one or more features in accordance with the subject specification. The subject specification (e.g., in connection with resource identification and/or collaboration) can employ various MLR-based schemes for carrying out various aspects thereof. For example, a process for determining when to select a resource, how to represent a resource, how to configure a layout/page, etc. can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject specification can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining, a current activity, user or environment context, relevant resources to a current context, appropriate rendition of resources in accordance with a context, etc.

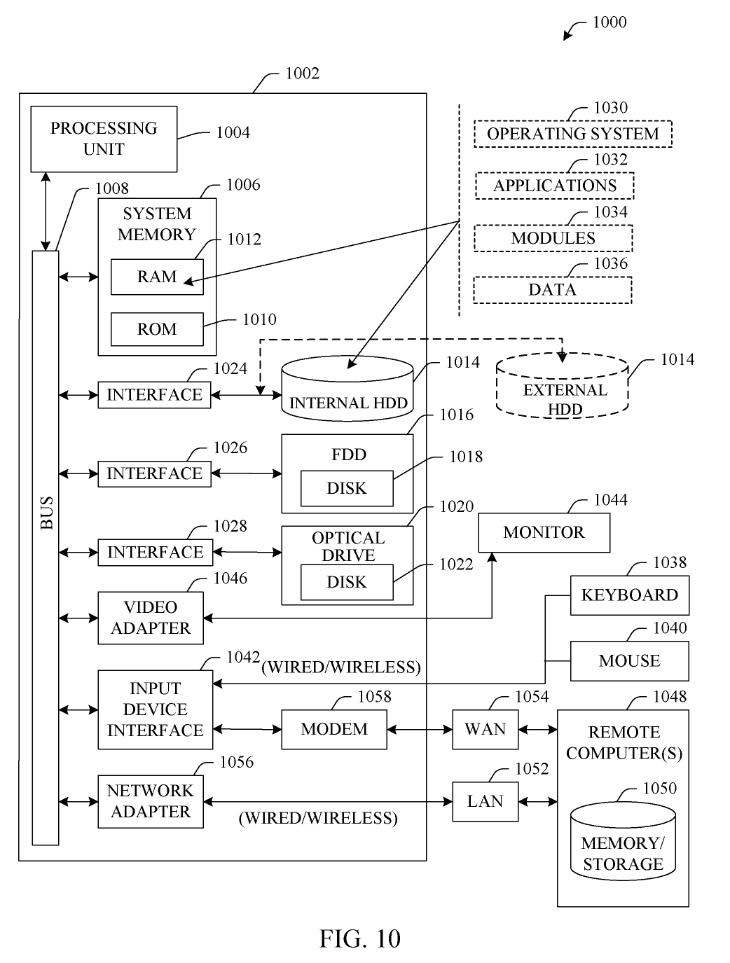

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

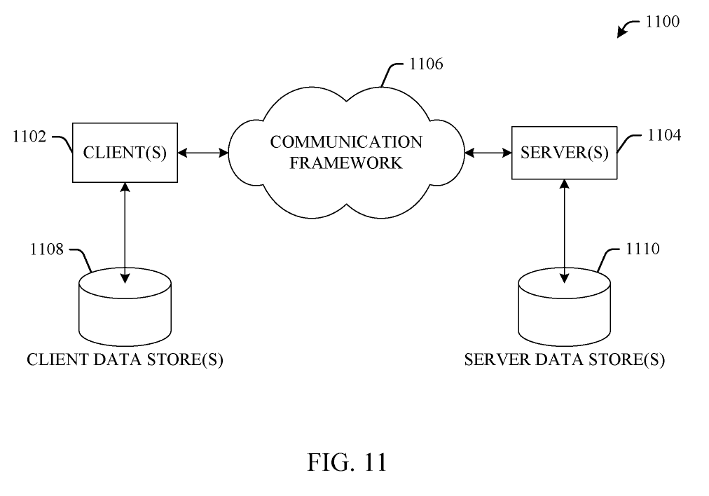

Referring now to FIG. 11, there is illustrated a schematic block diagram of an exemplary computing environment 1100 in accordance with the subject specification. The system 1100 includes one or more client(s) 1102. The client(s) 1102 can be hardware and/or software (e.g., threads, processes, computing devices). The client(s) 1102 can house cookie(s) and/or associated contextual information by employing the specification, for example.

The system 1100 also includes one or more server(s) 1104. The server(s) 1104 can also be hardware and/or software (e.g., threads, processes, computing devices). The servers 1104 can house threads to perform transformations by employing the specification, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the specification. It is, of course, not possible to describe every conceivable combination of components or methodologies for purposes of describing the subject specification, but one of ordinary skill in the art may recognize that many further combinations and permutations of the specification are possible. Accordingly, the specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a collaboration component that dynamically aggregates a plurality of resources associated with a workflow, wherein the workflow corresponds to a business environment; and
a virtualization rendering component that dynamically displays a spatial representation of a depiction of each of a subset of the plurality of resources based upon context.

2. The system of claim 1, wherein the depiction is at least one of an avatar, statue, image, or textual symbol.

3. The system of claim 1, further comprising a monitor component that establishes the context, wherein the context is one of an activity context, a user context or an environment context.

4. The system of claim 1, further comprising a resource configuration component that one of constructs or arranges representations of each of the subset of the plurality of resources.

5. The system of claim 4, wherein the resource configuration component dynamically adjusts the spatial representation as a function of the context of actions performed inside or outside a virtual environment.

6. The system of claim 1, further comprising a content generation component that employs analysis of audible or textual conversations to determine or infer the context, wherein the context is employed to aggregate the subset of the plurality of resources.

7. The system of claim 1, further comprising a contacts generation component that establishes association to a plurality of contacts, wherein identity of each of the plurality of contacts is employed to aggregate the subset of the plurality of resources.

8. The system of claim 1, further comprising a context generation component the establishes the context in real-time, wherein the context includes at least one of an activity context, a user context or a environment context, and wherein the context is employed to aggregate the subset of the plurality of resources in real-time.

9. The system of claim 1, further comprising a device analysis component that determines an appropriate rendering of the spatial representation, wherein the appropriate rendering is based upon characteristics of a display device.

10. The system of claim 1, further comprising a localize/normalize component that translates each of the subset of resources based upon a user context.

11. The system of claim 1, further comprising a resource arrangement component that establishes the spatial representation of the subset of resources based upon a preprogrammed or inferred relevance to the workflow.

12. The system of claim 1, wherein the spatial representation is a two-dimensional rendering that dynamically updates in accordance with the context.

13. The system of claim 1, wherein the spatial representation is at least one of a two-, two and a half-, or three-dimensional rendering that dynamically updates in accordance with the context.

14. The system of claim 1, further comprising a machine learning & reasoning component that employs at least one of a probabilistic and a statistical-based analysis that infers each depiction and layout of the spatial representation.

15. A computer-implemented method for visually rendering a contextually-based immersive collaborative display, comprising:
monitoring context of a user;
analyzing the context;
employing the analysis to gather a plurality of resources that are relevant based upon the context, wherein the plurality of resources are at least one of data, documents, individuals or applications; and
rendering a spatial representation that depicts a subset of the plurality of resources.

16. The computer-implemented method of claim 15, further comprising determining a suitable depiction for each of the resources, wherein the suitable depiction is inferred as a function of one of type or relevance.

17. The computer-implemented method of claim 15, further comprising determining the spatial representation based upon an inferred relevance to the context.

18. A computer-executable system, comprising:
means for dynamically inferring an activity context;
means for establishing a plurality of resources based upon the activity context, wherein the plurality of resources includes files, contacts or applications;
means for generating a depiction of each of the plurality of resources based upon a viewer's context; and
a visualization component that establishes a spatial representation of the depictions of each of the plurality of resources.

19. The computer-executable system of claim 18, further comprising means for inferring relevance of each of the plurality of resources, wherein the spatial representation is based upon relevance.

20. The computer-executable system of claim 18, further comprising means for determining the viewer's context.
